(19) United States
(12) Patent Application Publication
(10) Pub. No.: US 2007/0198353 A1
(43) Pub. Date: Aug. 23, 2007

(54) Method and system for creating and distributing and audio newspaper

(76) Inventors: Robert Paul Behringer, Hartville, OH (US); James Dewey Bunnell, North Canton, OH (US)

Correspondence Address: FRED ZOLLINGER III, P.O. BOX 2368, NORTH CANTON, OH, 44720, US

(21) Appl. No.: 11/709,580

(22) Filed: Feb. 22, 2007

Related U.S. Application Data
(60) Provisional application No. 60/775,914, filed on Feb. 22, 2006.

(51) Int. Cl. G06Q 30/00

(52) U.S. Cl. 705/14

(57) ABSTRACT

An audio newspaper system obtains or receives non-audio content items from a publisher and converts them into audio format content items. As part of the conversion, the software may be configured to create summaries from the content items. The summaries may include an overall news summary or headline summaries for different content categories. Advertisements may be associated with the audio format content items. Images may be associated with the audio format content items. The management software than provides access to the users who play selected audio format content items. The system may track and report user data back to the publisher or advertiser.

### CROSS REFERENCE TO RELATED APPLICATIONS

This application claims the benefit of U.S. Provisional Patent Application Ser. No. 60/775,914 filed Feb. 22, 2006; the disclosures of which are incorporated herein by reference.

### BACKGROUND OF THE INVENTION

1. Technical Field

This invention generally relates to a system and method for assembling and delivering an audio newspaper that obtains content from traditional published news sources. Specifically, the invention relates to a method and system for creating and delivering an audio newspaper system wherein both the publisher and the user control the format and content of the audio newspaper.

2. Background Information

Local newspapers offer the best and most detailed source of local news content. TV, radio, and the Internet offer a great deal of national news coverage, but do not offer the same level of detailed local stories. Newspaper users have been limited to reading their local newspaper's content in print, pushed to their mobile devices as text, or read online via computer system. The growing number of low cost, portable mobile devices such as iPods®, MP3 players, and cell phones offers newspaper publishers an alternative media in which to distribute their content.

Printed newspapers offer the detailed local news coverage and a variety of personal interest stories; however, users must have the time and physical capabilities to read this content. An audio newspaper offers the same local content to the blind, those with poor eyes, the elderly, business travelers, commuters, and any others who prefer listening to news rather than reading it.

Text-to-speech conversion software requires individuals to gather their own news and manually convert the text stories into audio files. These files must then be manually downloaded to the mobile audio device. The audio files produced are not easily accessible in traditional newspaper format such as by publication, section, and articles.

A few newspapers offer audio summaries of their daily newspaper or podcasts of special interests. These formats do not allow users access to the full content of the newspaper, nor are users able to choose the stories they want to listen and easily skip the others. Typically, these are formatted as one large audio file and are not easily accessible in traditional newspaper format such as by publication, section, and articles.

The National Federation of the Blind provides a service that converts newspaper text to audio format accessible via the telephone. Various companies offer audio version of their books, newspapers and magazines. Some are available as podcasts. Other services allow the user to obtain different text files and then use text-to-speech conversion software to generate audio format files. Despite the existence of these services, room for improvement remains in the art. Publishers desire a system and a method for creating an audio version of their publication while maintaining control over the publication. The publishers also desire to control the advertising revenue generated from the audio format newspaper.

### SUMMARY OF THE INVENTION

One configuration of the invention provides a method for assembling an audio newspaper that includes all of the content of a published newspaper while being retrievable by the titles of the articles. The audio newspaper may include advertisements that accompany the written articles. Images that are published with the written articles may accompany the audio files to allow the person listening to the article to selectively view the images.

Another configuration of the invention is the method of automatically assembling the audio newspaper on a day to day basis without extensive human interaction. The system allows the audio newspaper to be automatically created and prepared for distribution.

Another aspect of the invention is a method of generating advertising revenue by selling advertisements that accompany audio format content items accessed by a user. A publisher is able to generate the advertising revenue by providing its publication in an audio format to a group of users who listen to the content items and advertisements. The publisher then sells advertising spots within the audio format newspaper to generate revenue.

One configuration of the invention provides a method for assembling the content of a traditional local or regional printed newspaper or periodical into an audio file that may be selectively played on any of a variety of devices. The method includes the steps of tagging the content of the printed media in a manner that allows the media to be selectively played in an organized manner by the end user. This method allows the end user to select the stories by subject matter and/or headline in a manner similar to the manner in which a person reads printed media. The method may embed the advertisements into the files so that the end user is exposed to the advertisements.

In one configuration, the invention provides a method of creating and delivering a news publication to a user in an audio format wherein the news publication has a plurality of content items in text format created by a publisher; the method including the steps of: (a) defining a plurality of content categories for a selected publication; (b) selecting content items to be available in the plurality of content categories; (c) converting the selected content items to audio format content items; and (d) providing user access to the audio format content items so that the user may play the audio format content items on a media player.

Another configuration of the invention provides a method of creating and delivering a news publication to a user in an audio format wherein the news publication has a plurality of content items in text format created by a publisher; the method including the steps of: (a) defining a plurality of content categories; (b) allowing the publisher to select content items to be available in the plurality of content categories wherein each content item includes a headline and a story body; (c) converting the content items selected in step (b) to audio format content items; (d) defining a subset of the selected content items and converting only a portion of each selected content item of the defined subset to generate an audio format summary of each selected content item in the defined subset; and (e) providing access to a user to each audio format content item and each audio format summary.

In another configuration, the invention provides a method of delivering a news publication to a user in an audio format wherein the news publication has a plurality of content items in text format; the method comprising the steps of: (a) obtaining a plurality of text format content items from the publisher of the news publication and converting them to audio format content items; (b) obtaining an advertisement to be associated with at least one selected content item; (c) associating the advertisement with the selected content item; and (d) delivering the audio format content items and advertisements to the user in a manner that exposes the user to the advertisement associated with the audio format content item when the audio format content item is played.

In another configuration, the invention provides a method and system for creating and distributing a personalized audio newspaper for individual users comprising the steps of: (a) gathering media material in the form of content items with any associated photos, audio clips, advertisements in text or audio format with any associated advertiser image; (b) converting the content items to audio files via enhanced Text-to-Speech or human recording and are embedded with corresponding images modifying each audio file's ID3 tags; (c) proofing and approval process for advertising supplied by publishers; (d) hosting the audio files in a database equipped with subscription registration services via phone or via the World Wide Web; (e) providing specialized software to be downloaded onto Mac or PC computers or onto J2ME enabled cell phones to automate the downloading of the users customized audio newspaper to the user's Player of choice; and (f) tracking the downloaded content and advertisements by publication and storing the data in a database.

These configurations operate individually or in combination.

### BRIEF DESCRIPTION OF THE DRAWINGS

FIG. 1 is a summary flowchart showing an overview of one configuration for the system.

FIG. 2 is flowchart showing exemplary components and functions of the audio newspaper system according to the invention.

FIG. 3 is a flowchart depicting the four different functional areas of the system.

FIG. 4 is a flowchart showing how the content items may be converted to audio format content items.

FIG. 5 is an exemplary upper level display showing different tools used by the publisher to control the appearance and content of the audio newspaper.

FIG. 6 is an exemplary display showing an exemplary content manager tool.

FIG. 7 is an exemplary display showing an exemplary category editor tool.

FIG. 8 is an exemplary display showing an exemplary summary manager tool.

FIG. 9 is an exemplary display showing an exemplary top stories manager tool.

FIG. 10 is an exemplary display showing an exemplary story manager tool within a category.

FIG. 11 is an exemplary display for an editing tool.

FIG. 12 is an exemplary display for a text advertisement association tool.

FIG. 13 is an exemplary display for a audio advertisement association tool.

FIG. 14 is an exemplary demographics report.

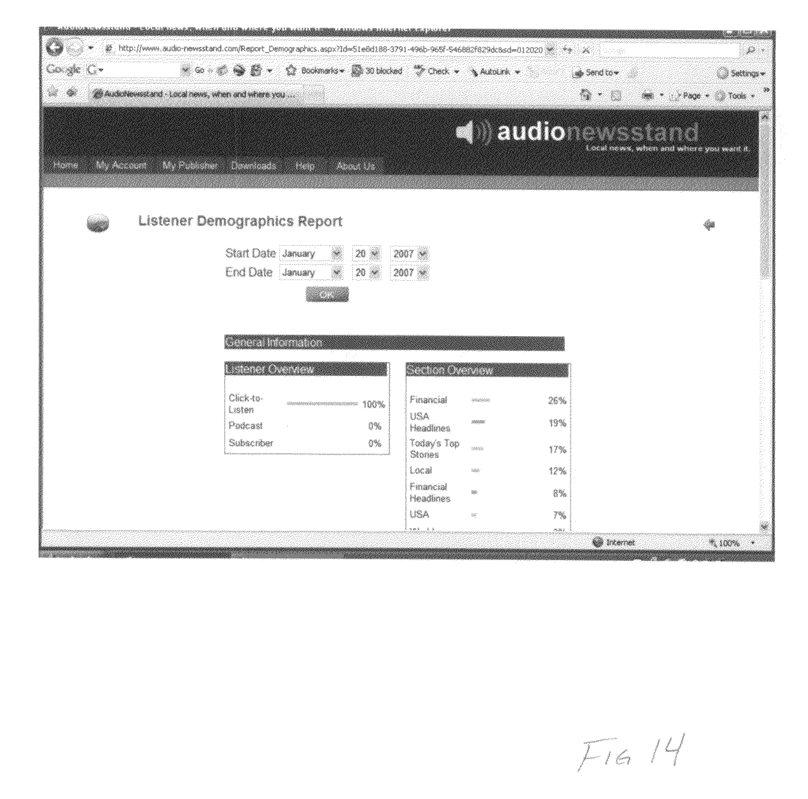

### DETAILED DESCRIPTION OF THE INVENTION

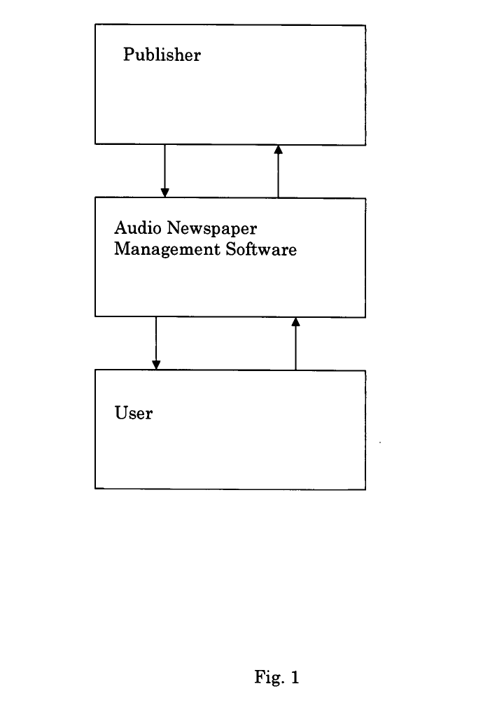

The system (and the corresponding methods) depicted schematically in FIG. 1 allows a publisher to generate an audio newspaper that may be played by a user. This audio newspaper provides initial publisher control of the content items and arrangement of the audio newspaper while providing secondary customization options to the user. The system allows the publisher to associate advertisements with the audio content. Optionally, the system allows the publisher to associate images with the audio content. When images are associated with audio files, some audio players allow the user to view the image while the audio content is playing.

In the context of this application, a “publisher” refers to something or someone who distributes readable materials to the public. The readable material may be distributed to the public via human readable computer files (such as those displayed on a website) or traditional printed human readable materials (such as a printed newspaper or printed magazine). An example of a publisher is a traditional newspaper publisher that employs a variety of people to perform different tasks that lead to the publication of the newspaper in print and on the website.

In the context of this application, the term “content item” refers to the information created by or obtained by the publisher to distribute to the public. In this application, advertisements are considered independent of a content item because the publisher typically charges a fee to the advertiser for publishing the advertisement while the content items are provided to give the user an incentive to read or listen to the publication. Advertisements are thus considered to be separate from content items in the context of this application even though most advertisements contain some information that may be considered a content item. Examples of content items are thus any news story or news item traditionally published in a newspaper, website, or magazine (typically including at least a headline followed by a story body), information presented in a list (such as sports scores, event schedules, or TV listings), an obituary, a weather forecast, and the like. A content item may include (not all are required) a headline, a byline, a story body, a story identifier, the name of the publication where it will be published, a section identifier, a run date, and a version identifier. Publishers may also add metadata to content items to associate the stories with searches, users, or advertisements. The metadata may include key words or profile tags. These are used to match delivery of content items to users with specific profiles and to users who enter key words.

In the context of this application, the term “audio format content item” refers to a computer readable file that, when played by a player (various types of players may be used such as a desktop computer player, a cell phone, a mobile personal player (such as an iPod®), a vehicle player, and the like) is audible and understandable to a human.

In the context of this application, the term “user” may refer to a human who subscribes to the system to obtain periodic updates. The term “user” also refers to any human who manually accesses the system from time to time to obtain audio format content items even when the user is not a subscriber. In another context, the term “user” may refer to a computer server that accesses the system to obtain audio format content items to be played on an automated system.

The audio newspaper system provides an audio format newspaper that the user may access and listen to while driving, exercising, flying, or working on the computer on other matters (playing the news in the background while working on other software). One use for the system is to provide a user access to a local newspaper when the user does not have time during the day to read the paper. A user who enjoys local news may use this system to access local news during times when reading is impossible. The system thus increases the efficiency of the user's day. For example, the user may download the audio newspaper to a portable player and listen to the local newspaper during his morning commute. Travelers, military personnel, those working out of town, vacationers, and snowbirds may use the system to remain up to date on local news. Those with poor eye site may also use this system to access the news.

The system provides a new mechanism for publishers to deliver content items and advertisements to users. The system provides controls that allow the publisher to maintain desired product identity. The publisher may thus use the system to build its brand as well as increase advertising revenue. Advertisers benefit from the system by selecting the characteristics of the users to whom the advertisements will be directed. Advertisers also receive feedback reporting whether or not the users play the stories having the advertisements and the type of users exposed to the advertisements. The advertisers also benefits from the opportunity to select the format of the advertisement presented to the users.

### 1. Audio Newspaper Management Software

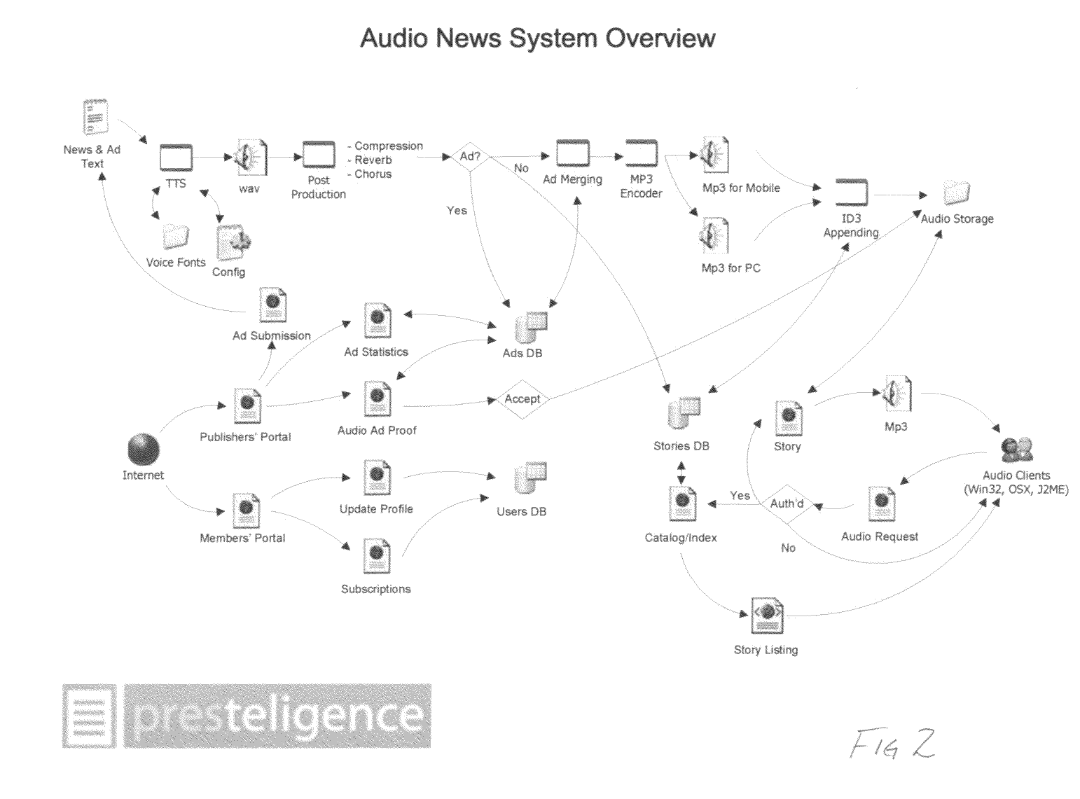

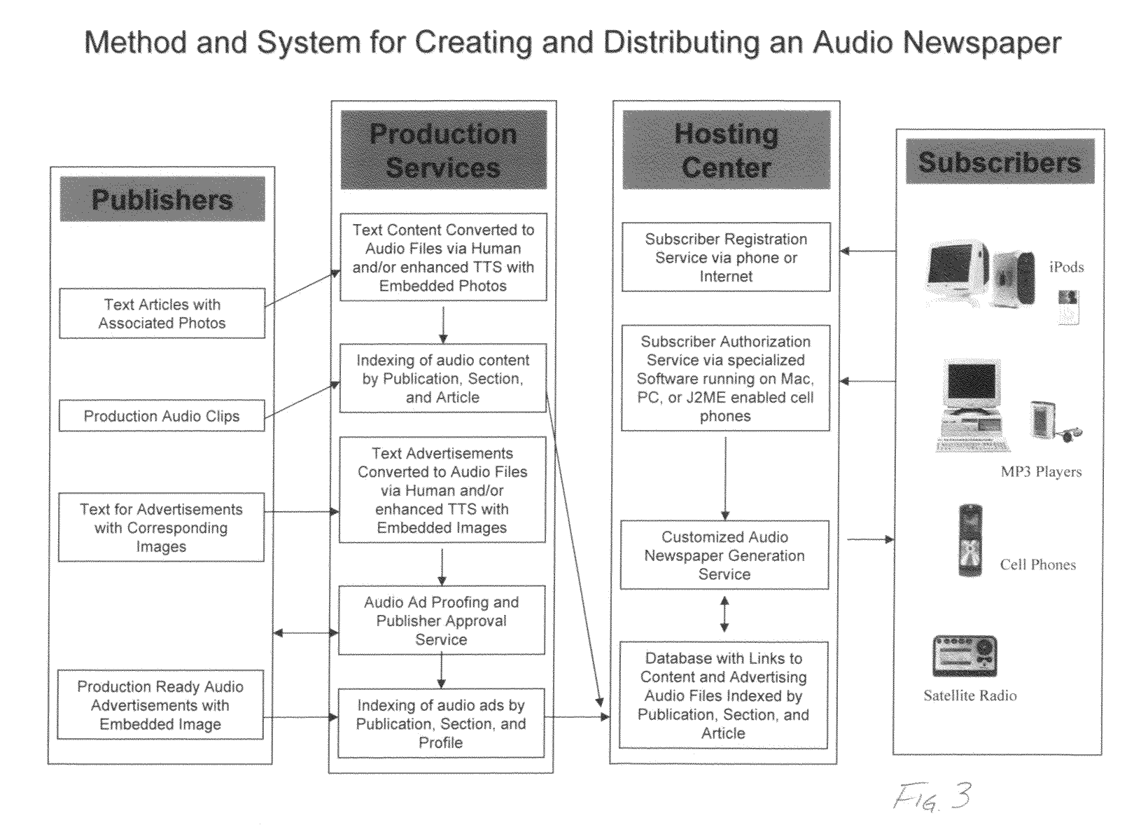

The audio newspaper system of the invention includes audio newspaper management software. The functions of the software are described in FIGS. 1-4. The management software may be provided in a single unit installed at a single location or as a plurality of programs installed on different computers, such as the publisher's computers, a host computer for an audio newspaper management website, and the user's computer or media player. The management software may include a publisher component, an assembly and delivery component, and a user component. Specific features and functions of the software are described below. In one embodiment of the invention, the software resides on a server that is accessed by the publishers and users. The software may also include a component that is installed on the user's computer. This component functions to automatically update new content items. In an exemplary embodiment of the invention, the management software runs on a server with feed gathering software that downloads feeds (content items) via RSS or receives feeds via FTP. The server also runs the text-to-speech conversion software. Delivery of the audio format items is performed via the Internet through web browsing software. A publisher needs only to have standard web browsing software to create an audio newspaper. The users are able to access the website to obtain audio format content items or the user may install software to automatically check for and download updated content. This software is designed to automatically snyc with media player software such as iTunes®. The management software also allows users to listen to the audio format content items directly from the management software through the Internet.

In general, the management software obtains or receives non-audio content items from a publisher and converts the content items into audio format content items. Overviews of these systems are depicted in FIGS. 1-3. Advertisements and images may be associated with the audio format content items. These audio format content items are provided to users so that they may listen to the content items on their media players. The software may be configured to periodically access the publisher's software to download content items to the management software. The software may track and report user data back to the publisher or advertiser.

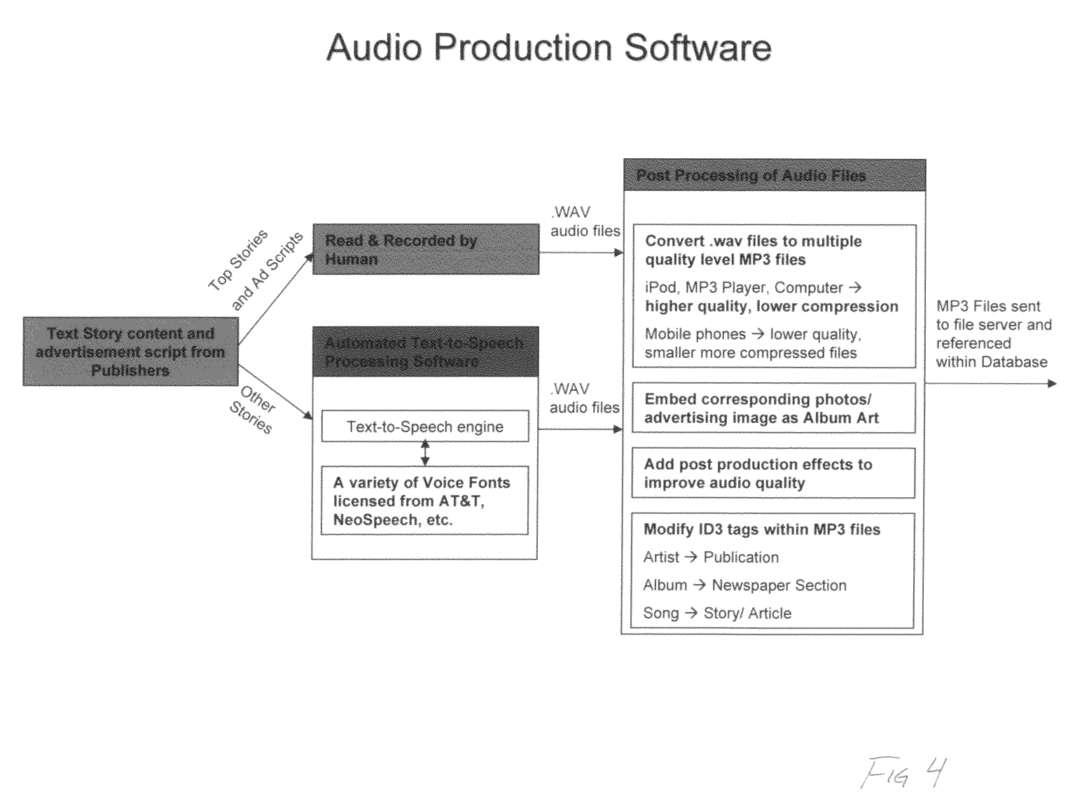

The text-to-audio conversion may use third party text-to-speech software engines or text-to-speech services. The conversion process is schematically depicted in FIG. 4. As part of the conversion, the software may be configured to create summaries from the content items. In one configuration, the summary may be converted to the audio format with a human voice actor. Once converted to audio format files (typically *.WAV files), different format MP3 files are generated to work on different media players. Any images are embedded and the ID3 tags are modified to reflect information about the publication. For example, the Artist ID3 tag may be changed to “Publication,” the Album tag may be changed to “Newspaper Section,” and the Song tag may be changed to “Story/Article.” Once these steps are performed, the files are stored on a database ready for access by the user.

In one embodiment of the system, a website is used to manage a plurality of publications for a plurality of users. Each user registers for a particular or a plurality of news subscriptions. The user may be required to provide an E-mail address, a password, a Zip code, an age, and a gender. This information is used in reports provided to the publishers and advertisers to describe who is exposed to the content items and the advertisements. The user may then select content categories or content subcategories that he wishes to receive (headlines only, by section (such as local news, local sports, weather), filter stories by key word, etc.). If the user selects only the Local News and Local Business subcategories, then only audio format content items in the Local News and Local Business subcategories are supplied to the user. If the user has authorized the delivery of additional stories based on the user profile or key words, then the user will receive additional stories from other subcategories that match the profile or key word. The user then chooses if the software is to automatically update or manually update the content. If the user selects automatic updates, the software component residing on the user's computer periodically connects with the management software and checks for and downloads updates.

When files are downloaded to a player or directly accessed from the website of the management software, the user may listen to the complete audio newspaper, a specific category or subcategory, only the headlines, or specific content items using song navigation controls built into most players. When the audio format content items are created, the ID3 tags within the MP3 files are added to denote publication, section, article, and playing order. The ID3 tags are changed by the management software after the content items have been converted, any advertisement and images have been embedded, the MP3 files have been created. These tags are used by the media player to allow the user to navigate through the audio newspaper.

The management software tracks the items accessed and the profile of the users who accessed the items. This data may be provided to the publisher or advertiser to assist with the sales of advertising or to modify the organization of the audio publication.

Software is provided for the users to download for use with different computers and different media players. The software residing on the user's computer or player automatically checks for audio newspapers to which they subscribe at a defined time each day via the Internet to computer servers hosting the user's profile information. The server software verifies the username and password of the user, making sure they have authorized access to the audio publication. The hosting service returns a list of content to download based on the users profile. The software connects to the servers storing the audio newspaper content and downloads only the content desired based on the user's profile. The software automatically moves the audio newspaper to the user's player of choice. In addition, the software cleans up older editions automatically.

### 2. Publisher

In the course of publishing its publication, the publisher creates content items. The content items may be generated by employee, freelance, or syndicated reporters, authors, or photographers or may be automatically assembled into lists from data. The publisher optionally may add key words and user profile metadata to the content items for use with its website and the audio newspaper system of the invention. This metadata is used to identify content items to a user who matches the profile or to a user who has enter a similar key word. The content items made be stored in a variety of different computer files such as *.txt, *.pdf, *.xml, *.rss and the like. The management software may be configured to obtain images associated with the content items and associate the images with the audio format content items. These content items are made available to the audio newspaper management software for conversion to the audio format content items. For example, the publisher assembles the content items in its publication software or on its website. The audio newspaper management software may be configured to access the content items from the publishing software or the website to convert the items to audio format content items. If the publisher does not want to allow such access, the publisher may also transfer the content items to the management software. Once the management software obtains the content items and images (and advertisements as described below), the software converts the content items to audio format content items in accordance with the rules defined by the publisher. The management software includes a feed gathering software component that either downloads feeds via RSS or receives feeds via FTP. The feeds come from the publisher's content system or the management software downloads the content from the publisher's web sites. The management software can receive feeds throughout the day and periodically checks for new content throughout the day.

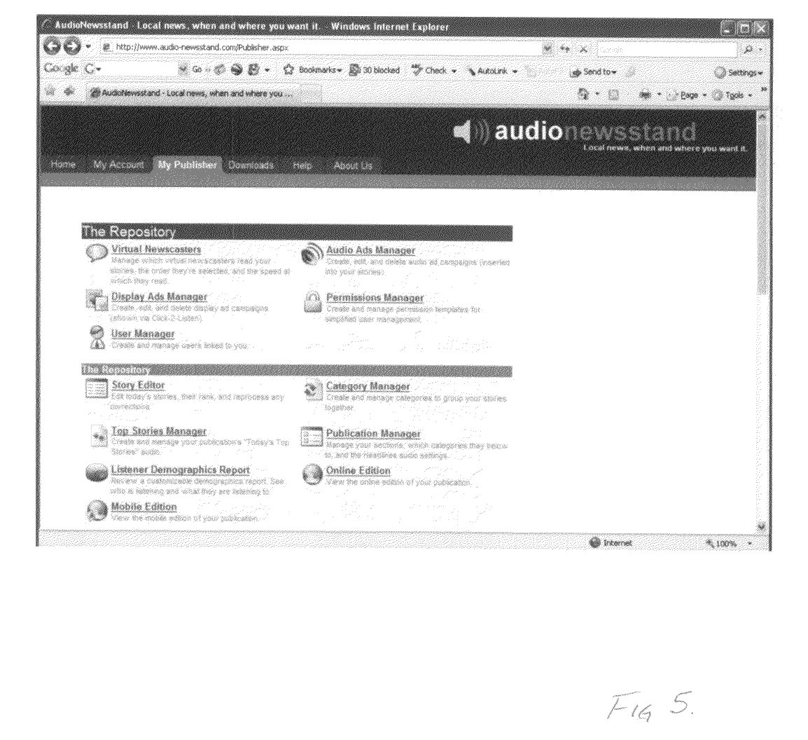

The audio newspaper method and system of the invention allows the publisher to control the organization and presentation of the audio newspaper to the user. FIG. 5 depicts an exemplary screen from publisher management software that defines options for the publisher. To use the system, the publisher only needs a standard Web browser. The publisher does not need any software running within their systems to send content items or place advertisements. The publisher is provided with links to the management software which they can embed within the pages of their web site or they can simply provide a link from their web site to a publisher specific page on the management software's web site which is branded for the publisher and gives their users access to audio versions of their content. The system is thus likely to be readily adopted by those publishers who wish to maintain control over their brand. The result is that the end user is likely to receive a desirable audio newscast that is easy to listen to. Such customers are likely to return and access additional newscasts thus generating an advertising market for the publisher. The system and method of the invention thus provides a method of generating advertising revenue to a publisher.

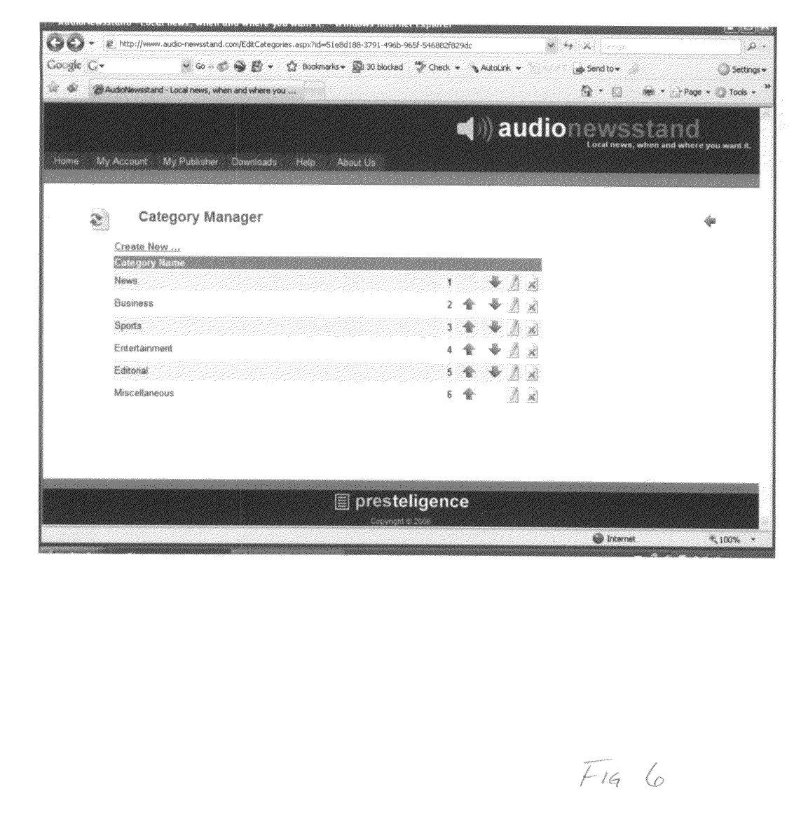

One manner in which the publisher maintains control over the newscast is by defining the categories and subcategories in which content items are presented. In most cases, the categories match the major sections of the publication with the subsections matching the minor sections of the publication. For example, the publisher may elect to present the audio format newspaper in the major sections such as the News, Business, Sports, Entertainment, Editorial, and Miscellaneous categories depicted in FIG. 6. The publisher may then elect to define subcategories for each category. For example, the News category may include subcategories for Local, Main Story, State, USA, and World. The management software allows the publisher to define, alter, order, and delete these categories and subcategories. The publisher manages their audio newspaper products via a web browser interface to the publisher portal on the management software web site. The management software includes web site services software which processes their requests and interacts with a SQL database also running on the management software servers.

FIG. 6 depicts the management software tools that allow the publisher to customize the content categories. These tools allow the publisher to define the names of the categories as well as the order of the categories. Categories may be created and deleted and the names of the categories may be revised. The order of the categories is the default order of the audio format content items presented to the user. The user may change the order of the newscast using the software in the user's audio player. In one example, the publisher may define subcategories for Local News, State News, National News, and World News; Local Sports, State Sports, and National Sports; and the like. The publisher then associates its content items and advertisements with these subcategories. The definition and management of the content categories provides a benefit to the system that allows the publisher to control the product being presented to the user.

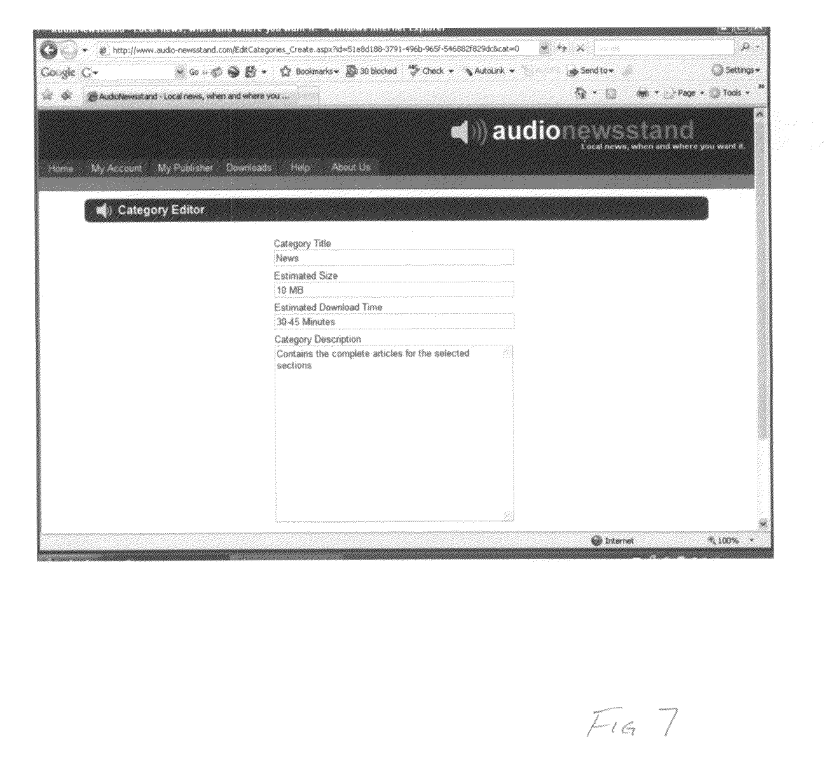

FIG. 7 depicts information about a category that is obtained by analyzing the publisher's typical publication. The information tool of FIG. 7 helps the publisher plan how many content items are to be used for the audio newspaper. This information may be automatically generated by analyzing the content items in the category to determine the size of the download and the length of the audio format file if all content items are converted.

Each content item includes at least a headline and a body. The software may be configured to automatically generate a headline summary of each of the headlines in a category or subcategory. The summaries are created by combining all of the headlines within a category or subcategory. These headline summaries are provided to the user independent of the audio format content items. This allows the user to select a headline summary for a category or a subcategory that plays all of the headlines back-to-back for all of the content items in the selected category or subcategories.

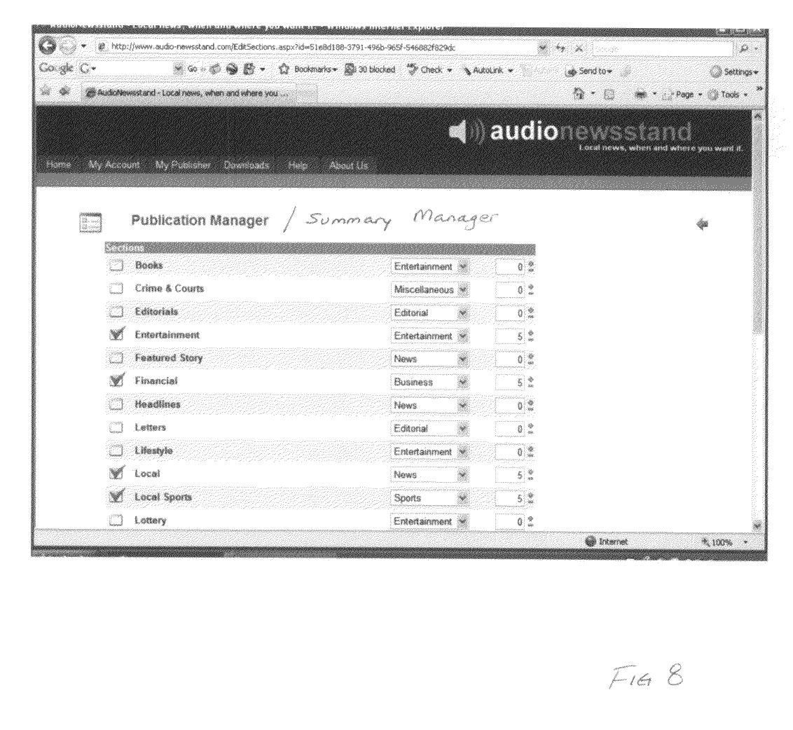

FIG. 8 depicts an optional summary manager tool that allows the publisher to define a custom audio news summary that is created as a separate audio format content item for the user. This summary is particularly useful to a user who desires a news summary in a single audio format file. If the publisher elects to provide a summary, the publisher selects (with the check marks on the left side of the screen) subcategories and defines the number of content items for selected subcategory (with the numbers on the right side of the screen) to be included within the audio news summary. The publisher may choose to change these summary definitions from time-to-time to give the users a different feel to the audio newspaper.

When the software obtains the content items to create the audio format content items, the software automatically generates the audio news summary by converting a portion of each story selected in the summary manager. The portion of the story to be included in the summary may be defined to be the a fixed number of characters or words in the content item, the headline and a fixed number of paragraphs of the content item, the headline and a fixed number of words or characters of the content item, or the headline and the paragraphs that contain a minimum number of words or characters. For example, the audio news summary may include an audio conversion of the headline and the first 500 characters of text plus any additional words up to the end of the paragraph (or sentence) containing the 500^{th} character. Thus, if the 500 character limit causes the conversion to stop in the middle of a sentence, the conversion continues with the unfinished fraction of that sentence (or paragraph). The summary assembles the items in the order of the categories defined by the publisher. This audio summary file is provided as an option to the user in a single audio file. In an alternative embodiment, the audio summary is custom produced using a human voice actor.

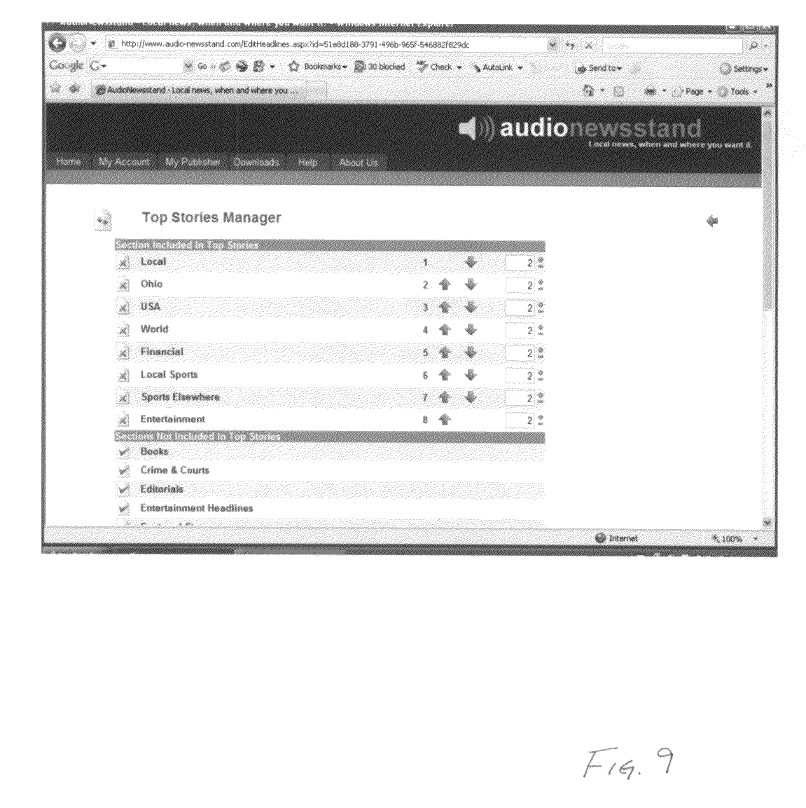

FIG. 9 depicts a top stories manager tool that allows the publisher to define a custom Top Story Summary that is created as a separate audio format content item for the user. If the publisher elects to provide a Top Story Summary, the publisher selects story categories or subcategories (on the left side of the screen) and defines the number of content items for selected category or subcategory (with the numbers on the right side of the screen) to be included within the audio top story summary. The publisher may also customize the order of the categories to set the order of the content items. The publisher may choose to change these summary definitions from time-to-time to give the users a different feel to the audio newspaper. The audio format top stories manager may be created using the same type of rules described above with respect to the audio news summary.

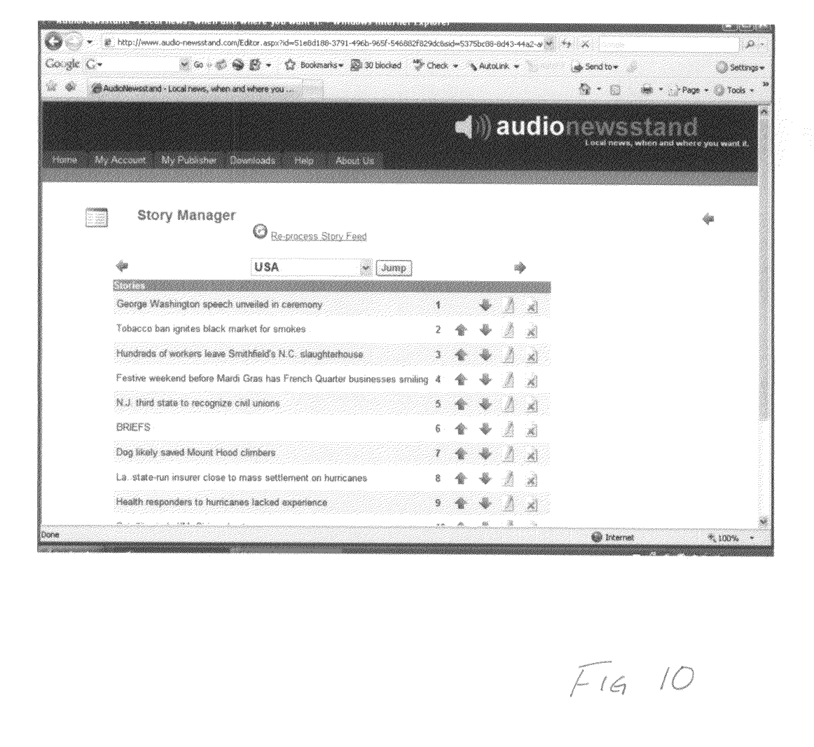

FIG. 10 depicts a story manager tool that allows the publisher to add content items to, delete content items from, and to order the content items within a category or subcategory.

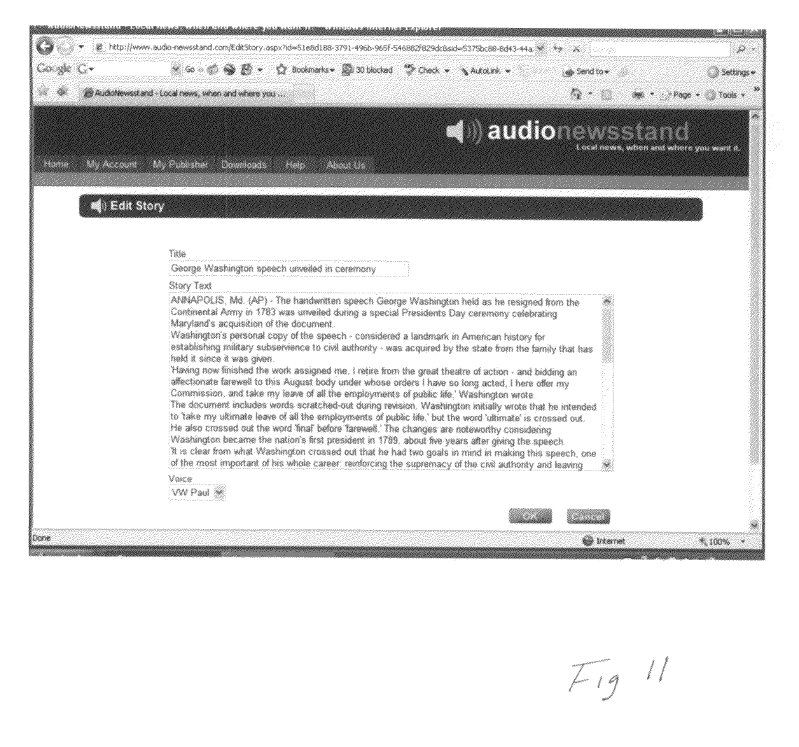

FIG. 11 depicts an editor for a content item. This editor allows the publisher to select the voice which will be used during the text-to-speech conversion. The editor also allows the publisher to edit the headline and body of the content item.

### 3. Advertising

Once the publisher is using the system to provide access to its content items, the publisher may advertise the existence of the audio newspaper site to potential users. A publisher will typically advertise the system through the publisher's website. The publisher may also advertise the existence of the audio newspaper through other marketing mediums such as television, radio, billboards, and other traditional promotional tools. This self promotion may also be coupled with an effort to sell advertising within the audio newspaper to establish a new source of revenue for the publisher.

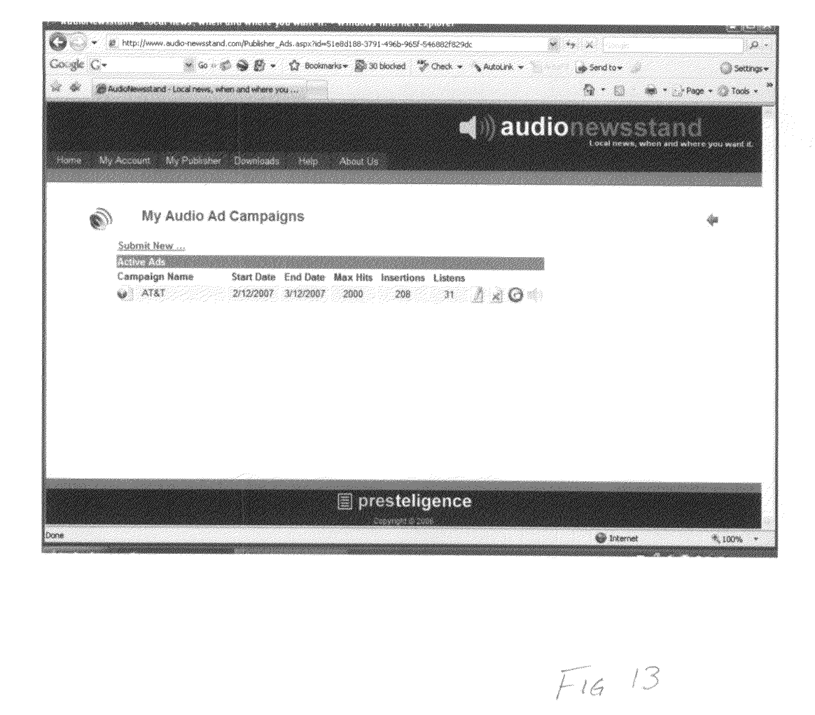

The publisher sells advertisements that are to be associated with different portions of the audio newspaper. The publisher associates the advertisement with a particular portion of the audio newspaper such as a single content item, a subcategory, a category, the top stories summary, the audio news summary, a combination of some of these or all of these. The association (or ad placement) is flexible. For example, an advertisement may be associated with each sports-related summary while another advertisement may be associated with only the financial-related content items. The publisher and advertisers negotiate the fees associated with each placement, how long the advertisement will run, or how many times the advertisement will run. The fees also may be based on the number of times the user downloads or listens to the advertisement. The management software tracks (as shown for example in FIG. 13) the number of times the advertisement has been played and how many times it has been inserted.

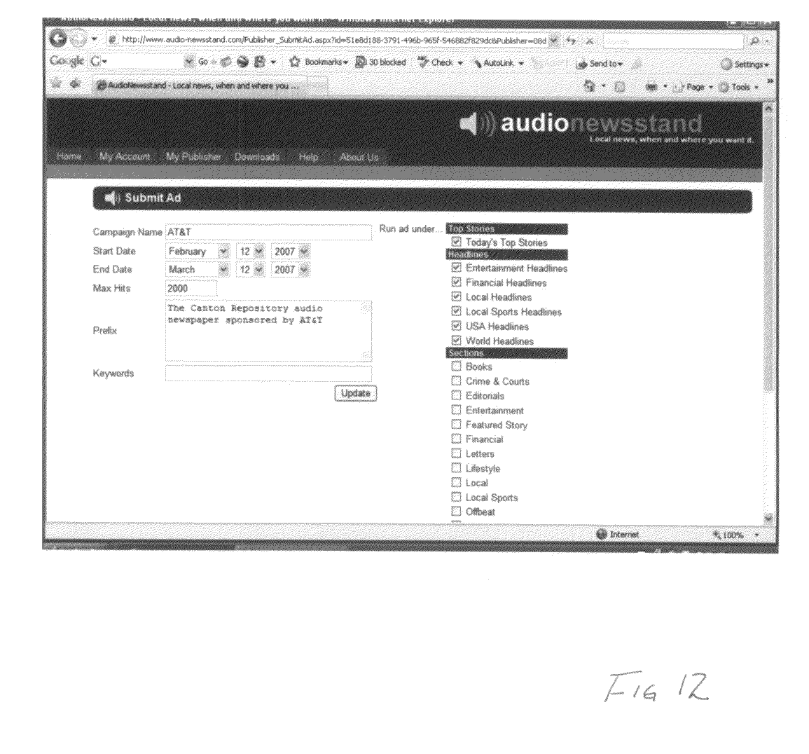

The advertisements may be provided to the publisher in text format or audio format. FIG. 12 depicts an example of how a text format advertisement may be associated with the top stories and headline sections of the audio newspaper. A date range may be assigned. A maximum number of runs may also be assigned. In this example, the text for the advertisement is simply entered at this location. The text advertisement also may be provided from the advertiser. This text is associated with each of the selected items and converted to audio format along with the content items so that a single audio format content item also includes the audio format advertisement. In another embodiment, the text advertisements are converted independently of the content items and associated later. Advertisements may also be provided in an audio format generated by the advertiser. The audio format advertisement is associated with the selected content item, subcategory, or category. These audio advertisements are embedded with the audio format content items and are automatically played when the user plays the audio format content items. The advertisers may also provide image format advertisements that are provided to be displayed when the user plays the associated content item.

The software also allows a prefix advertisement such as a “brought to you by” line to be inserted before a content item in addition to a traditional, longer advertisement. An example of a prefix ad is depicted in FIG. 12 where the “brought to you” by text will be played before the Top Stories and Headlines sections.

The advertisements may be maintained in an advertisement database. When a space is available for an advertisement insertion, the management may search the database for an appropriate advertisement. If multiple advertisements are available for the space, selection criteria may be used to select to ad to be inserted. The criteria may include the number of times the ad has been inserted, the run time of the ad, the revenue being generated by the ad, etc. Each advertisement in the database may include key word metadata that may be used to place the ads. For example, a gold store may use a “golf” key word to associate its advertisement before each content item related to golf.

The audio format newspaper described herein provides a useful system and method for creating and distributing a audio newspaper to a group of users. It is to be understood that any variations evident fall within the scope of the claimed invention and thus, the selection of specific component elements (such as software selections and subroutines) can be determined without departing from the spirit of the invention herein disclosed and described. The scope of the invention shall include all modifications and variations that may fall within the scope of the attached claims.

1. A method of creating and delivering a news publication to a user in an audio format wherein the news publication has a plurality of content items in text format created by a publisher; the method comprising the steps of:
(a) defining a plurality of content categories for a selected publication;
(b) selecting content items to be available in the plurality of content categories;
(c) converting the selected content items to audio format content items; and
(d) providing user access to the audio format content items so that the user may play the audio format content items on a media player.

2. The method of claim 1, further comprising the steps of allowing the user to select at least one content category from the selected publication and making audio format content items available to the user from only the selected content category.

3. The method of claim 2, further comprising the step of allowing the user to select key words and providing the user access to any audio format content items related to the key words provided by the user regardless of the category of the content items.

4. The method of claim 1, further comprising the step of associating an advertisement with a content item so that the user is exposed to the advertisement when the user plays the audio format content item.

5. The method of claim 4, further comprising the step of allowing the publisher to control the association of the advertisement with the content item.

6. The method of claim 5, further comprising the step of associating an audio format advertisement with the content item.

7. The method of claim 5, further comprising the steps of associating a text format advertisement with the content item and converting the text format advertisement with the content item in step (c).

8. The method of claim 4, further comprising the step of storing advertising data related to the delivery of the advertisements to users and reporting the advertising data to the publisher.

9. The method of claim 1, wherein steps (a) and (b) are performed by the publisher.

10. The method of claim 1, further comprising the steps of allowing the publisher to establish the order of the contents items within each content category and maintaining the publisher's order when the user is provided access to the audio format content items.

11. The method of claim 1, further comprising the steps of identifying a subset of content items and generating an audio format summary of the identified subset of content items.

12. The method of claim 1, further comprising the steps of identifying a subset of categories and generating a headline summary for each of the headlines in the subset of categories.

13. The method of claim 1, further comprising the steps of periodically checking with the publisher for new content items and repeating steps (c) and (d) for the new content items.

14. The method of claim 1, further comprising the steps of associating an image with a content item and of delivering the associated image with the audio format content item accessed by the user.

15. The method of claim 1, wherein the audio format content items are MP3 format and further comprising the step of modifying the ID3 tags within the MP3 files to relate to identify the title of the news publication and to index the content item.

16. A method of creating and delivering a news publication to a user in an audio format wherein the news publication has a plurality of content items in text format created by a publisher; the method comprising the steps of:
(a) defining a plurality of content categories;
(b) allowing the publisher to select content items to be available in the plurality of content categories wherein each content item includes a headline and a story body;
(c) converting the content items selected in step (b) to audio format content items;
(d) defining a subset of the selected content items and converting only a portion of each selected content item of the defined subset to generate an audio format summary of each selected content item in the defined subset; and
(e) providing access to a user to each audio format content item and each audio format summary.

17. The method of claim 16, further comprising the steps of defining headline and story subcategories; allowing the user to select individual subcategories; and delivering audio format content items and audio format summaries to the user for only those selected subcategories.

18. The method of claim 16, wherein step (d) includes the step of converting the headline and a portion of the story body to generate the audio format summary.

19. The method of claim 16, wherein step (d) includes the step of defining the portion being converted by one of a number of characters, words, sentences, and paragraphs.

20. A method of delivering a news publication to a user in an audio format wherein the news publication has a plurality of content items in text format; the method comprising the steps of:
(a) obtaining a plurality of text format content items from the publisher of the news publication and converting them to audio format content items;
(b) obtaining an advertisement to be associated with at least one selected content item;
(c) associating the advertisement with the selected content item; and
(d) delivering the audio format content items and advertisements to the user in a manner that exposes the user to the advertisement associated with the audio format content item when the audio format content item is played.

21. The method of claim 21, wherein step (b) includes the step of obtaining a text format advertisement and converting the text format advertisement to an audio format advertisement.

22. The method of claim 22, wherein step (c) is performed after the text format advertisement is converted to an audio format advertisement and the audio format advertisement is associated with an audio format content item.

23. The method of claim 22, wherein step (c) is performed before the text format advertisement is converted to an audio format advertisement and the advertisement and content item are converted together.
